(19) United States
(12) Patent Application Publication
(10) Pub. No.: US 2008/0037817 A1
(43) Pub. Date: Feb. 14, 2008

(54) Earphone

(75) Inventors: Susanne Ewert, Berlin (DE); Markus Hohl, London (GB); Joachim Scholz, Hambuehren (DE); Katrin Huss, Hannover (DE)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(73) Assignee: Sennheiser electronic GmbH & Co.KG

(21) Appl. No.: 10/591,260

(22) PCT Filed: Mar. 2, 2005
(86) PCT No.: PCT/EP05/50917

§ 371 Date: Apr. 26, 2007

(51) Int. Cl. H04R 1/10

(52) U.S. Cl. 381/380; 381/370; 381/371; 381/384

(57) ABSTRACT

There is provided an in-ear earphone having an electroacoustic transducer and at least one support element which is coupled to the transducer. That makes it possible to achieve two-point anchorage for the earpiece in the outer ear, wherein the transducer represents the first anchorage and the support element represents the second anchorage.

### CROSS-REFERENCE TO RELATED APPLICATIONS

This application claims priority of International Application No. PCT/EP2005/050917, filed Mar. 2, 2005 and German Application No. 10 2004 010 198.1, filed Mar. 2, 2004, the complete disclosures of which are hereby incorporated by reference.

### BACKGROUND OF THE INVENTION

a) Field of the Invention

The present invention concerns an in-ear earphone, a band-less headphone and an earclip headphone.

b) Problems Addressed by the Inventors

In-ear headphones or earphones represent small earphones or headphones which can be fitted into the outer ear. In that case the electroacoustic transducer of the earphone is usually fitted into the outer ear.

In-ear earphones of that kind however are often felt to be uncomfortable after being worn for a prolonged period of time and in regard to a number of users the in-ear earphones regularly drop out.

### OBJECT AND SUMMARY OF THE INVENTION

Therefore the primary object of the present invention is to improve the wearing comfort of in-ear earphones.

That object is attained by an in-ear earphone in accordance with the invention which comprises a first and second support element with a predeterminable fixed spacing therebetween wherein the first support element is in the form of an electroacoustic transducer and wherein the spacing between the first and second support elements is such that the second support element is anchorable in a concha of a wearer of the in-ear earphone.

Thus there is provided an in-ear earphone having an electroacoustic transducer and at least one support element which is coupled to the transducer. That makes it possible to achieve two-point anchorage for the earpiece in the outer ear, wherein the transducer represents the first anchorage and the support element represents the second anchorage.

In accordance with an aspect of the present invention the spacing between the support element and the electroacoustic transducer is so selected that the support element can be anchored in the concha of a wearer of the in-ear earphone. That therefore ensures secure fixing of the in-ear earphone in the ear.

In accordance with a further aspect of the present invention the support element is biased with respect to the electroacoustic transducer, thereby providing for improved adaptation in the ear.

In accordance with a further aspect of the present invention the support element is interchangeable. That improves the hygiene of the earphone and defective support elements can be readily replaced.

The invention further concerns a band-less headphone comprising at least two electroacoustic transducers and connecting elements associated with each transducer for connection to corresponding connecting elements which are associated with another electroacoustic transducer. In that way the two electroacoustic transducers of a headphone can be connected together for example for storage.

In accordance with an aspect of the present invention the connecting elements represent magnets so that there is a magnetic connection.

The invention further concerns an earclip headphone comprising at least two electroacoustic transducers, at least one loop for hooking in an ear and an ear pad which has an outward bulge portion which is suitable for acoustically sealingly coupling to an auditory canal of a wearer.

The acoustic sealing coupling of the ear pad permits improved bass transmission of the electroacoustic transducer.

The invention is described in greater detail hereinafter by means of the embodiments by way of example and with reference to the accompanying drawings.

### BRIEF DESCRIPTION OF THE DRAWINGS

FIG. 1 shows various outside views of an in-ear earphone in accordance with the first embodiment;

FIG. 2 shows an in-ear earphone of FIG. 1 in an ear;

FIGS. 3A, 3B and 3C show in-ear earphones in accordance with a second embodiment;

FIG. 4 shows various views of an earclip headphone in accordance with a third embodiment;

FIG. 5 shows an outside view of a packing for headphones in accordance with a fourth embodiment;

FIG. 6 shows a packing for a headphone in accordance with a fifth embodiment; and

FIG. 7 shows a packing for headphones in accordance with the sixth embodiment.

### DESCRIPTION OF THE PREFERRED EMBODIMENTS

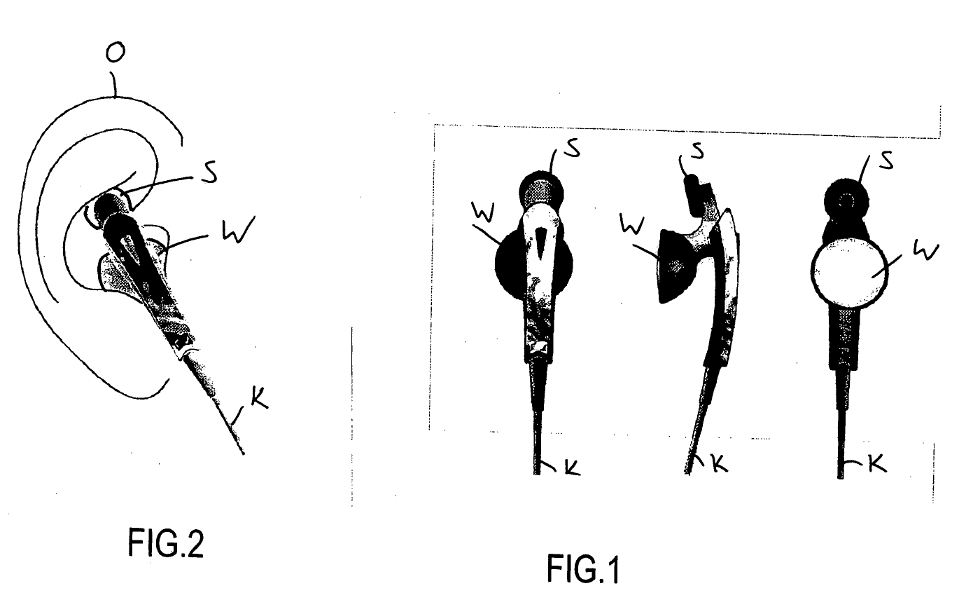

FIG. 1 shows three different views of an in-ear earphone in accordance with a first embodiment. The in-ear earphone has a cable K and an electroacoustic transducer W. In addition the in-ear earphone has a support element S. The support element S is aligned with the cable K.

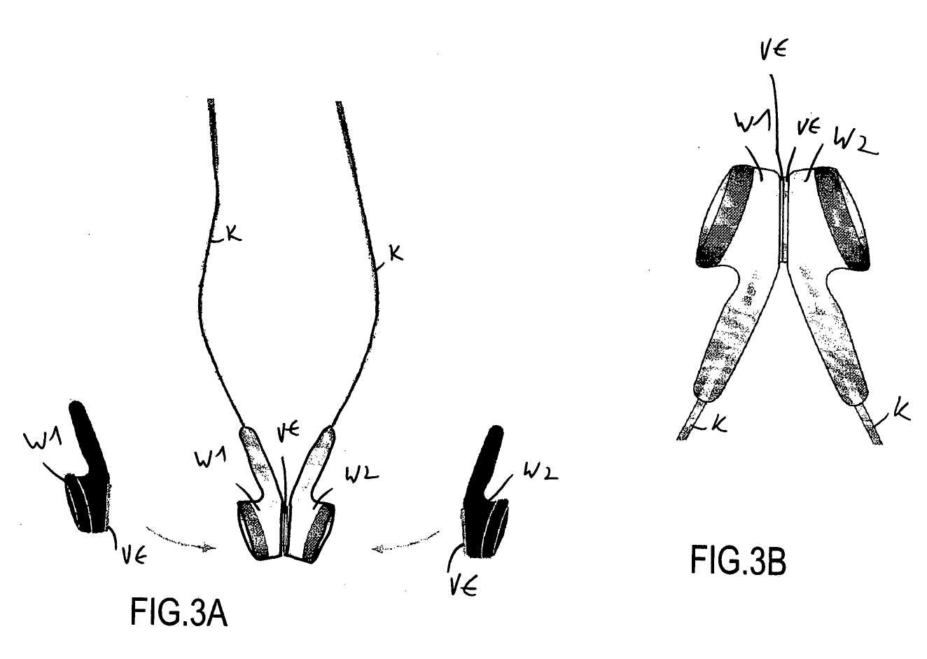

FIG. 2 shows a diagrammatic view of the in-ear earphone which is shown in FIG. 1 and which is inserted into an ear 0. In that situation the transducer W is disposed above the auditory canal and the support element S is anchored in the concha. That therefore permits secure fixing of the in-ear earphone in the ear by means of a two-point anchorage in the concha. The support elements S can be interchangeable, they can assume various shapes and/or can be of a rotatable eccentric configuration. In addition the support elements S can be of a self-adapting nature.

To improve the fixing in the ear the support elements S are resiliently biased with respect to the transducer W. Alternatively to the earphone shown in FIGS. 1 and 2 with only one support element S, it is also possible to provide earphones which have more than one support element S so that this permits N-point mounting of the earphone in the outer ear, wherein N>2. The support elements can also be biased relative to each other.

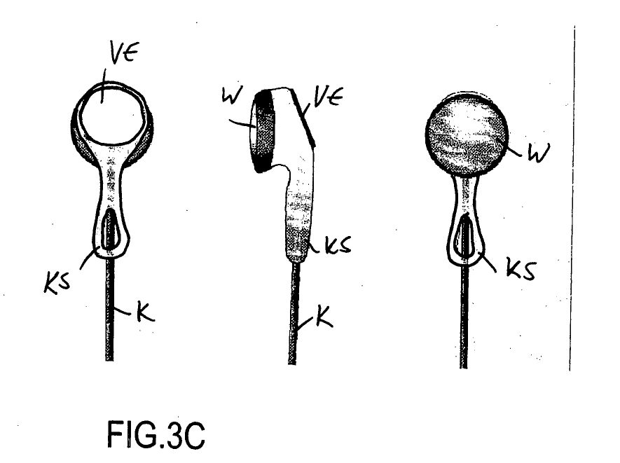

FIGS. 3A, 3B and 3C each show a respective outer view of an in-ear earphone in accordance with the second embodiment. The two earphones (left and right) each comprise a casing connected to a cable K. Disposed in the casing is a respective transducer W1, W2 and, on the side opposite to the transducer, a connecting element VE. The two connecting elements VE of the earphone are in this case of such a configuration that they can be connected to the respective other connecting element.

FIG. 3B shows a view on an enlarged scale of the in-ear earphone of FIG. 3. The casing is also connected to a cable K and has a transducer W1, W2 as well as a connecting element VE on the rear side of the casing. The connecting elements VE can for example represent magnets so that the connection between the two connecting elements can be made magnetically, the magnets being of reversed polarities. Alternatively to the magnets, the connecting elements VE can be in the form of press studs, hook-and-loop closures or in the form of a force-locking or positively locking connection.

FIG. 3C shows various views of the in-ear earphone in accordance with the second embodiment. The casing has an electroacoustic transducer W, connecting elements VE at the rear side of the casing and a cable kink prevention means KS at the location of the connection of the casing to the cable. The kink prevention means prevents the cable from being kinked at the connecting location and damaged.

The in-ear earphone in accordance with the first embodiment as shown in

FIGS. 1 and 2 can also have the connecting elements VE and the cable kink prevention means described in relation to the second embodiment.

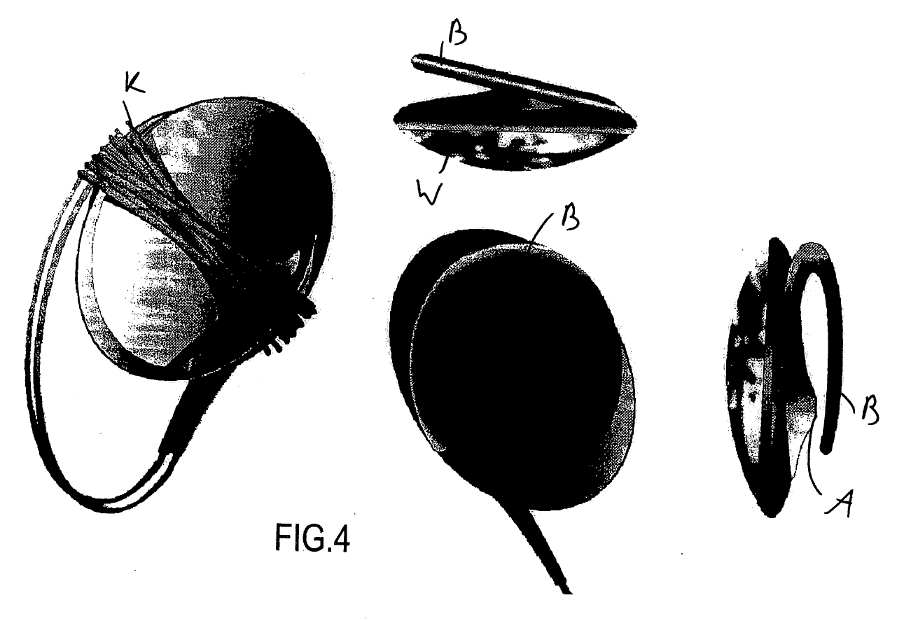

FIG. 4 shows various views of an earclip headphone. That headphone has a loop B which can be fitted over the outer ear so that the headphone can be securely fixed over the ear. The ear pad of that earclip headphone is of such a configuration in this case that, when the headphone is fitted on to an ear, the outwardly shaped portion A of the earphone couples substantially acoustically sealingly to the auditory canal of the user.

That acoustic sealing coupling improves in particular bass transmission. The cable kink prevention means shown in FIG. 3C can also be used.

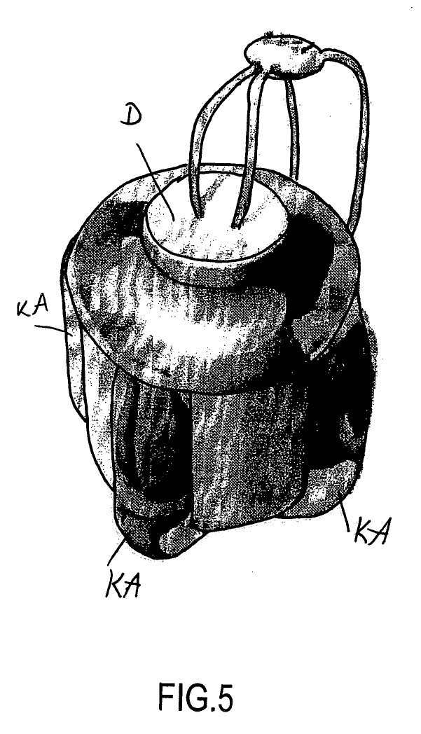

FIG. 5 shows a view of a packing for the headphones shown in FIGS. 1 through 4 in accordance with a fourth embodiment. In this case the packing has a lid D as well as at least four inflatable air chambers KA. A container, for example of fabric, is provided between the air chambers KA.

The content of the container or the packing is protected by the inflatable air chambers.

In this case the lid D can be fitted in accurately fitting relationship like a cork into the opening of the packing.

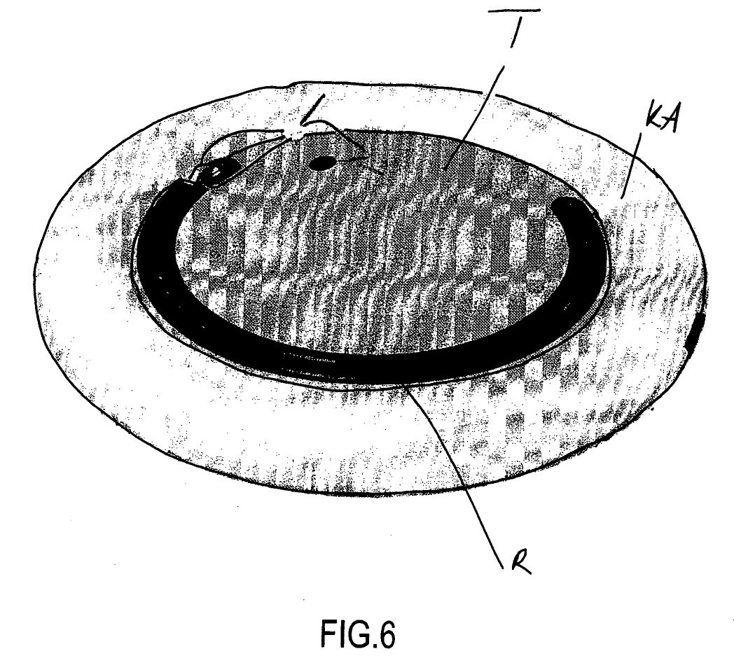

FIG. 6 shows an outer view of a packing in accordance with the fifth embodiment. The packing has an annular inflatable air chamber KA and a pocket T in the interior of the inflatable ring. The packet has a zip fastener R for opening and closing the pocket. In this case the headphones described with reference to FIGS. 1 through 4 can be stowed in the pocket.

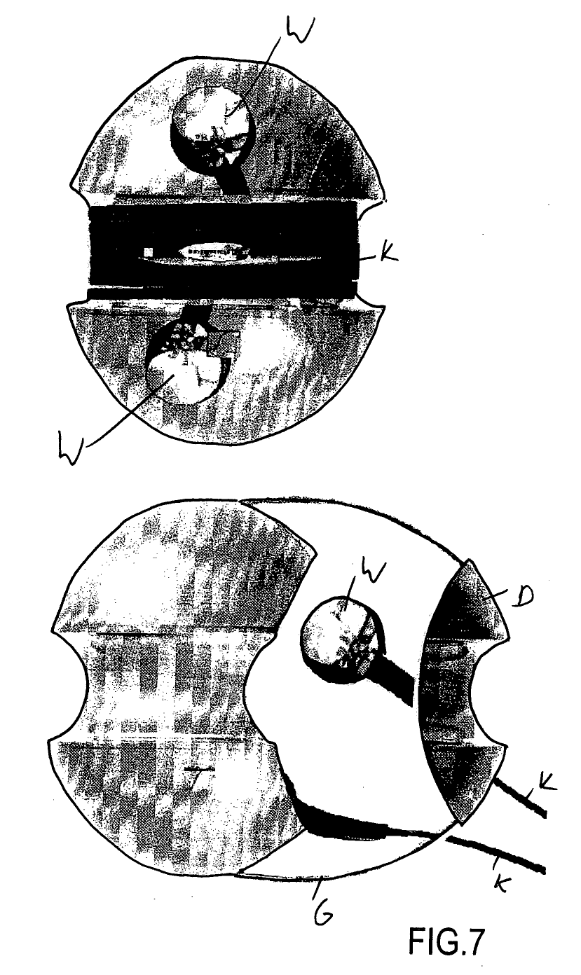

FIG. 7 shows an outer view of a packing in accordance with the sixth embodiment. The packing with an in-ear earphone is shown in the upper view. In this case the earphone is disposed in the interior of the packing (shown here as being transparent) and the cable of the earphone is wrapped around the packing.

The lower view shows the packing in its opened condition, with the lid D being fixed to the rest of the packing by two rubber cords C. In this case the transducers are fitted into the interior of the packing, the lid of the packing is closed and the cable of the earphone is wrapped around the packing.

While the foregoing description and drawings represent the present invention, it will be obvious to those skilled in the art that various changes may be made therein without departing from the true spirit and scope of the present invention.

1-6. (canceled)

7. An in-ear earphone comprising:
a first and a second support element with a predeterminable fixed spacing therebetween;
said first support element being in the form of an electroacoustic transducer; and
said spacing between the first and second support elements being such that the second support element is anchorable in a concha of a wearer of the in-ear earphone.

8. An earphone as set forth in claim 7 wherein the second support element is biased with respect to the first support element.

9. An earphone as set forth in claim 7 wherein the second support element is of an interchangeable nature.

10. A band-less headphone comprising:
at least two electroacoustic transducers; and
at least one connecting element associated with each electroacoustic transducer for connection to corresponding connecting elements of other electroacoustic transducers.

11. A headphone as set forth in claim 10 wherein the connecting elements are in the form of magnets.

12. An earclip headphone comprising:
an electroacoustic transducer;
at least one loop for hooking engagement on an ear; and
an ear pad which is adapted to acoustically sealingly couple to an auditory canal.
